(19) United States
(12) Patent Application Publication
(10) Pub. No.: US 2024/0249373 A1
(43) Pub. Date: Jul. 25, 2024

(54) CURRICULUM MANAGEMENT AND ENROLMENT SYSTEM

(71) Applicant: REQUISITE ENROLMENT SOLUTIONS PTY, Coolum Beach (AU)

(72) Inventor: Graham Ashford, Buderim (AU)

(21) Appl. No.: 18/628,299

(22) Filed: Apr. 5, 2024

Related U.S. Application Data
(63) Continuation of application No. 17/786,858, filed on Jun. 17, 2022, now abandoned.

(30) Foreign Application Priority Data
Dec. 20, 2019 (AU) 2019904867

(51) Int. Cl. G06Q 50/20

(52) U.S. Cl. CPC G06Q 50/2053

(57) ABSTRACT

A curriculum management system is provided. The system comprises a data store comprising a plurality of coding elements, each coding element providing hierarchical prioritisation of a course in a program, and at least one server, the server configured to provide course suggestions for the program based at least in part upon the coding elements. Related curriculum management methods are also provided.

### CROSS-REFERENCE TO RELATED APPLICATIONS

This application is a continuation of U.S. patent application Ser. No. 17/786,858, filed on Jun. 17, 2022, and entitled “CURRICULUM MANAGEMENT AND ENROLMENT SYSTEM” which is a U.S. National Stage application filed under 35 U.S.C. § 371 of PCT/AU2020/051387, filed Dec. 17, 2020, which claims priority to, and the benefit of, Australian Patent Application No. AU2019904867A, filed Dec. 20, 2019, entitled “Curriculum management and enrolment system,” each of which is hereby incorporated herein by reference in its entirety.

### TECHNICAL FIELD

The present invention relates to curriculum management, and in particular (although not exclusively), to methods and systems for enrolment of students in courses at higher educational institutions.

### BACKGROUND ART

Programs at university level, such as bachelor's degrees, are generally associated with a plurality of courses which must be completed in order to meet the requirements of the program. These courses may include required courses and elective courses, which must be completed in order to complete the program. Subsets of courses may be grouped into study components such as a major or minor.

Programs are typically designed by teams of experts guided by curriculum design principles and curriculum design norms that together form a body of common practice among the higher education institutions. A widely accepted curriculum design principle is that, on completion of a program, students will have acquired and evidenced achievement of a set of pre-defined program learning outcomes that encompass essential and desirable skills and knowledge related to the discipline of study at a pre-defined standard.

To achieve these program learning outcomes, the program structure requires students to complete courses within which they learn and evidence achievement of course-level learning outcomes. Skills and knowledge are scaffolded by designing sequences of courses that begin with introductory material and progressively broaden the scope, depth, and complexity of instruction over the duration of the program. Course and program learning outcomes are typically constructively aligned, with evidence of students achieving the former being taken as evidence of students meeting the latter.

It is common that the programs that higher education institutions design and offer must meet standards set by external agencies. Such standards typically specify the volume of learning in the program and the skills and knowledge to be achieved by students on graduating from the program.

Although the application of common practice in curriculum design and the requirement to meet external standards can result in broadly similar program structures among higher education institutions globally, specific program rules and requirements regularly exhibit considerable differences within the same institution and across similar institutions.

For example, some programs allow students to exercise choice in the selection and timing of the courses they take or the major or minor they complete, whereas other programs have a set structure of courses that must be taken in a particular sequence. As another example, some universities offer their courses over three trimesters, others offer courses over two semesters, and others over a larger number of shorter intensive sessions. Furthermore, although programs at different institutions may share a similar title, such as Bachelor of Science, the major and minors and courses at the institutions will typically differ due to differences in the staffing profiles, research strengths, local career opportunities, and strategic objectives of the institutions. As a result, a study plan that will meet both the rules of a program and the study interests of a student can be highly institution and student specific.

To assist students to plan their studies and navigate the enrolment process, programs may include a recommended full-time study sequence or plan of courses, which ensures that the courses are completed in an order that complies with the rules associated with the program, and best meets the program goals. However, in many instances, students are not provided with a recommended study plan, and must instead develop their own plan e.g. by reading and interpreting the program rules and requirements and making course choice and sequencing decisions, with limited knowledge of how the curriculum was designed and how it would optimally be completed.

Where they are provided to students, recommended study sequences or plans can work relatively well when followed from start to finish with a full-time study load. However, they are typically far less helpful to students that choose to study part time (less than a full study load) or to students that need to deviate from the recommended full-time study sequence, for example because they enter a program with credit for prior study or their program structure has changed part way through their study.

As an illustrative example, when a student studying full time temporarily moves to part time and then wishes to go back to full time, the student may find it difficult to pick courses that best fill the program requirements. A similar problem exists if a student does not successfully complete a course as anticipated in the full-time recommended study sequence, or if a student has already studied some courses from the first year of a program, for example if they transfer between programs, as this may result in the student deviating from the recommended course sequence for the entire program.

Recommended full-time study plans take into account often complex program requirements, relationships between course learning outcomes within a year and across years, specific course dependencies (for example, some courses are pre-requisites for other courses), and the limited availability of courses in a given semester. Furthermore, the recommended full-time study plan assumes that the program requirements and course relationships and dependencies will be collectively met each semester through full-time study. Importantly, assumptions underpinning full-time study plants may no longer be valid when a student follows a non-standard study plan, such as when a student studies part time and progresses to the following semester without acquiring the totality of assumed knowledge that is anticipated by the four courses specified for that semester.

As an illustrative example of difficulties that can arise, where a full-time study recommended sequence indicates a student should complete four specific courses in the first semester, there is typically little additional guidance provided on which of those four courses they should take if they only choose to undertake a one, two, or three course part-time study load such that they are best prepared for undertaking courses available in the following semester.

In such cases, students are typically instructed to review their program handbook and work through the course selection process on their own to choose courses, after which they may log into an enrolment system to formally enroll in their chosen courses. In many instances, students are presented with the entire course catalogue from which they must find and select the courses. However, even where students are presented with only a subset of courses that directly relate to their program, there is generally insufficient additional information to help the student prioritise courses in a way that would best suit their learning and academic progress. As a result, a common outcome is that students choose courses that sound interesting or that their friends are enrolled in. This frequently results in the student taking courses out of their optimal sequence which may lead to the student being academically underprepared and less likely to succeed in the course. Taking courses out of sequence may also cause delays in a student completing a program, because early courses which are pre-requisites for later courses may not be completed.

More generally, whether a recommended study sequence is provided or not, students commonly encounter considerable difficulties identifying and sequencing their studies in a way that would most benefit their interests. Universities often employ advisors to assist students understand program rules and make appropriate study choices. However, the demand for personalised enrolment advice typically greatly exceeds the resources that universities allocate to providing it. As a result, students often do not receive such advice in a timely way. In more extreme cases, students simply become overwhelmed with the number of course choices, and fail to enroll into courses in time, and may ultimately drop out from a program.

Methods and processes to successfully automate the provision of accurate and consistent expert study planning and enrolment advice would benefit students and universities alike. Students would be more likely to progress in a timely way, develop skills and knowledge more successfully, and enjoy a better student experience. Universities would benefit reputationally as well as financially by being able to reduce student advising costs while also improving student retention, progress, and academic success. However, the diversity of program rules, the combinations of possible study sequences that arise when students can exercise choice in their program, and the dependencies between courses make automation of enrolment advice difficult in practice.

Relevant information to assist with effective enrolment advice is typically documented in a variety of formats and locations including policies and procedures, timetables, student handbooks, program rules and course descriptions. However, the frequently diffuse nature of this documentation, and the fact that it is commonly presented in a narrative or other format that requires interpretation, creates significant challenges for automation, and existing automated systems have proved ineffective for working with this information to consistently provide high quality student-specific optimal enrolment and study plan advice that expert human advisors can provide. Efforts to automate advice to date have instead tended to focus on providing students with course recommendations using approximation and association methods. These methods have significant limitations and may result in non-optimal advice.

Certain systems which recommend courses to students do exist. In particular, course recommenders exist which prioritise courses in programs that consistently receive positive feedback, that consistently have high grade outcomes, that are similar to other courses that a student has previously completed, or that most closely follow the courses that other students have completed who achieved high grade outcomes or completed their program most quickly.

Existing course recommenders have, however, several common problems. In particular, the methods of prioritisation used are generally not program-specific, and are not particularly well aligned with curriculum goals or factors that are strongly associated with knowledge and graduate outcomes. For example, a course may have positive student feedback and high grade outcomes, but not engender strong knowledge and skills acquisition because it is effectively too easy. In contrast, a course can be well designed and challenging and produce strong learning outcomes but have lower grade outcomes and less positive student feedback. Similarly, a recommender system that prioritises minimising a student's time to completion of a program may preference courses that do not materially contribute to the program learning outcomes or the desirable employment skills.

Furthermore, recommender systems that prioritise courses based on their similarity to courses a student has previously completed may bias the student's learning within a narrow discipline area and recover material that the student is already familiar with. Such recommender systems also require that the student has already completed one or more courses from which similar courses might be identified. This renders such recommender systems ineffective in guiding students that are starting in a program, which is typically when academic advice is most important.

More generally, optimisation algorithms exist which solve combinatorial optimisation problems. While on the face of it, it may appear reasonable to simply apply such optimisation algorithms to courses in a program, such algorithms do not take into account knowledge and skills acquisition, or desired outcomes of the program. Furthermore, the outcomes of such algorithms are generally a fixed sequence of elements, without any flexibility, and do not allow for any future flexibility.

Another important issue is that the use of optimisation algorithms to solve combinatorial optimisation problems requires access to a large volume of accurate and complete information on program rules, course characteristics, curriculum design intentions, and prior and future student study decisions that are codified in a way that the system can recognise and work with them. The current lack of curriculum management systems that capture, codify, and provide access to such information greatly reduces the usefulness and functionality of existing optimisation algorithms.

Given difficulties with existing automated course recommenders, advisors may be used to help students pick courses based upon their own experience and understanding of the program and the courses. Such expert advice is generally of a high quality, but is often inefficient and time-consuming to provide and obtain. As a result, expert advice is generally not able to be provided to all students in an effective manner.

In view of the above, there exists a clear need for improved curriculum management and enrolment systems and methods. In particular, there is a clear need for curriculum management and enrolment systems and methods that can facilitate the automation of both accurate and consistent expert advice regarding the optimal set of courses that a student should take in any given study period that would satisfy complex program requirements. Ideally, although without limitation, it would be desirable for new systems to be consistent with best-practice curriculum design, take account of course availability and dependencies, be informed by a student's prior study, and accommodate transition arrangements arising from program changes.

It will be clearly understood that, where prior art is referred to in the background, this reference does not constitute an admission that the prior art forms part of the common general knowledge in the art in Australia or in any other country.

### SUMMARY OF INVENTION

The present invention is directed to curriculum management and enrolment methods and systems, which may at least partially overcome at least one of the abovementioned disadvantages or challenges, and/or provide the consumer with a useful or commercial choice.

With the foregoing in view, a first aspect of the present invention provides a curriculum management system, comprising:
a data store comprising a plurality of coding elements, each coding element providing hierarchical prioritisation of a course in a program; and
at least one server, configured to provide course suggestions for the program based at least in part upon the coding elements.

Suitably, the curriculum management system can automate the provision of useful advice and thereby provide effective course guidance for a program, allowing for program-specific prioritisation of courses. By providing hierarchical prioritisation, multiple factors may be considered in the prioritisation, each having varying levels of importance. As a result, the system can capture considerable subtlety and nuance in prioritisation of the courses.

In embodiments, the data store comprises:
a plurality of course elements corresponding to a plurality of courses; and
a plurality of program elements corresponding to a plurality of programs;
wherein the coding elements are each associated with a program element and a course element, to thereby provide hierarchical prioritisation of the corresponding course in the corresponding program.

In embodiments, the hierarchical prioritisation of the course in the program is according to a plurality of factors. The plurality of factors may comprise at least two independent factors. The factors may be prioritised according to a hierarchy.

In embodiments, the coding elements provide hierarchical prioritisation of a course in a program independently of a prioritisation of other courses in the program. This enables courses to be added and removed, typically without the need to reprioritise courses with reference to each other.

In embodiments, the course suggestions are generated for a student taking into consideration one or more courses which the student has already completed. As such, the course suggestions may be customised to the student's particular academic situation.

Suitably, the coding elements, or codes thereof, are not visible to students when enrolling in courses.

In embodiments, the coding elements each comprise a code. The code may be coded according to one or more of: a preferred semester of the course in the program; a course level; a requirement of the course in the program, and whether the course is a pre-requisite for one or more future courses in the program. Each of these factors may be arranged according to a hierarchy of importance.

In embodiments, the codes comprise numeric or alpha-numeric codes.

In embodiments, the coding elements comprise a plurality of coding sub-elements.

In embodiments, the sub-elements are arranged in a hierarchical manner. The sub-elements may form a code comprising hierarchically arranged sub-codes. The sub-elements may be arranged in a sequence according to their hierarchy.

In embodiments, the plurality of coding sub-elements each comprise a numeric or alpha-numeric code. The numeric or alpha-numeric codes of the sub-elements may be arranged according to a hierarchy to form a numeric or alpha-numeric code of the coding element.

In embodiments, the coding sub-elements comprise a preferred study period sub-element, indicating a preferred study period (e.g. semester) of the course in the program.

In embodiments, the coding sub-elements comprise a course level sub-element indicating a level of the course (e.g. 100-level).

In embodiments, the coding sub-elements comprise a course requirement sub-element, indicating a requirement of the course in the program. The course requirement sub-element may also indicate its relation to other study components such as majors and minors.

In embodiments, the coding sub-elements comprise a pre-requisite sub-element, indicating whether the course is a pre-requisite for one or more future courses in the program.

The coding sub-elements may comprise non-binary sub-elements.

The coding element may comprise four characters A, B, C, and D, wherein each of the four characters is a letter or number. In embodiments, the four characters of the coding element are arranged in a string in the order A, B, C, D. In an embodiment, the four characters are in the form A.BCD (e.g. 3.251).

In embodiments, the A character denotes a study period characteristic of the course for the program; the B character denotes a study level characteristic of the course for the program; the C character denotes a requirement characteristic of the course for the program, e.g. recommended or elective (including in a major or minor); and the D character denotes whether the course is a pre-requisite characteristic of the course for the program.

Suitably, a lower value is given to required courses than recommended or elective courses for the C character.

Suitably, a lower value is given to courses that are pre-requisites for later courses than courses that are not pre-requisites for the D character.

Suitably, the coding elements are arranged such that each sub-element relates to a different aspect, yet the code as a whole can be considered without particular reference to the sub-elements.

The coding element may be extendable, e.g. by prepending, appending, or inserting additional characters.

The coding element may comprise a value, such as a number, wherein prioritisation of the course with reference to other courses is by comparing a magnitude of the value of the coding element of the course to coding element values of other courses in the program.

In embodiments, the course suggestions are provided based on minimising the magnitude of the value of the coding element or coding elements of the course or courses suggested.

In embodiments, the course suggestions are provided by solving an objective function using the coding element of the course and coding elements of other courses in the program.

Suitably, the objective function may comprise minimisation of the sum of codes of the coding elements. The minimisation may be performed according to courses available in a particular study period (e.g. semester). Similarly, the minimisation may be performed by choosing the courses with the lowest codes of the coding elements. The minimisation may be performed according to a number of courses that a student wishes to take.

The system may be configured to generate a list of courses available for enrolment by a student, and to perform the objective function on the list of courses available for enrolment.

The system may be configured to alter the course coding elements prior to performing the objective function.

In embodiments, after the initial course coding elements are assigned, elements within the course code are increased or decreased in magnitude to reflect other attributes of the course.

In embodiments, where a student has a choice of possible courses in a recommended study sequence, a course code element is changed to decrease the priority of one of the choices based on negative student feedback on the course.

In embodiments, a course code element is changed to increase its priority if the course will be discontinued in the future.

The system may be configured to generate a list of courses associated with a program, and to remove courses not available for enrolment by a student. Courses may be removed if they are not available in the study period. Courses may be removed if the student has not completed the appropriate pre-requisites. Courses may be removed if the student has already completed them successfully.

In embodiments, the system comprises, or is configured to provide, a graphical user interface. Suitably, a program administrator may define one or more coding elements relating to a particular program for display using the graphical user interface. The graphical user interface may display one or more questions, from which the coding elements are automatically generated. The questions may be grouped according to course, program, or study component.

In embodiments, the data store of the system comprises a plurality of student progression elements each corresponding to a student and a course, the student progression element comprising information regarding the completion of the course by the student.

In embodiments, the data store of the system comprises a plurality of student progression elements each corresponding to a student and a program, the student progression element comprising information regarding the completion of a version of the program by the student.

In embodiments, student-specific course coding is used to facilitate student transition from one version of a program to another.

In embodiments, the course suggestions are provided using one or more of the student progression elements in conjunction with the plurality of coding elements.

In embodiments, the course suggestions are provided in a user interface that enables the student to enroll in the courses therefrom. Suitably, the user interface is of or connected to the system of the first aspect.

In embodiments, a student is provided with a graphical user interface, and the course suggestions are provided in the graphical user interface.

Suitably, the graphical user interface enables the student to select an enrolment period (e.g. a semester), wherein the course suggestions are provided for the selected enrolment period.

Suitably, the graphical user interface enables the student to select a number of courses for enrolment, wherein the course suggestions are provided with reference to the selected number of courses.

The graphical user interface may comprise menus, such as drop-down menus, enabling the student to input data.

The graphical user interface may comprise scenario and planning tables that enable the student to compare alternative course choices and alternative study loads.

The graphical user interface may include the ability for the student to produce, save, and retrieve planning tables that compare alternative course choices and alternative study loads.

In embodiments, the graphical user interface enables one or more course suggestions to be viewed by program advisors, program administrators or similar. Preferably, the graphical user interface enables a student advisor or program administrator or the like to investigate a specific student's optimal study sequence independent of input by the student.

In embodiments, the graphical user interface enables the student advisor or program administrator to investigate the impacts of program or course selections, or changes, on one or more students' optimal study sequences independent of input by the students.

The graphical user interface may comprise scenario and planning tables that enable the student advisor or program administrator to compare alternative course choices and alternative study loads.

The graphical user interface may include the ability for the student advisor or program administrator to produce, save, and retrieve planning tables that compare alternative course choices and alternative study loads.

In embodiments, the graphical user interface enables the student advisor or program administrator to undertake other analysis, for example, to determine whether different combinations of majors and minors in a program can be completed within a set time period.

A second aspect of the invention provides a curriculum management method including:
receiving, on a data interface, a plurality of coding elements, each coding element providing hierarchical prioritisation of a course in a program; and
providing course suggestions for a program based at least in part upon the coding elements.

A third aspect of the invention provides a curriculum management method including:
providing course suggestions for a program based at least in part upon a plurality of coding elements, each coding element providing hierarchical prioritisation of a course in a program.

A fourth aspect of the invention provides a code, for providing hierarchical prioritisation of a course in a program. The code may comprise a numeric or alpha numeric code. The code may comprise a plurality of sub-elements, each sub-element relating to a different aspect of the course relative to the program.

Suitably, the method of the second or third aspect or the code of the fourth aspect is for operation of a curriculum management system. In embodiments, the curriculum management system is the system of the first aspect.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 illustrates a curriculum management system, according to an embodiment of the present invention.

FIG. 2 illustrates a screenshot of a program data entry screen of the system of FIG. 1, according to an embodiment of the present invention.

FIG. 3 illustrates schematic of a data structure illustrating a relationship between programs, courses and progression codes of the system of FIG. 1, according to an embodiment of the present invention.

FIG. 4 illustrates a screenshot of a student enrolment screen of the system of FIG. 1, according to an embodiment of the present invention.

FIG. 5 illustrates a curriculum management method, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention.

### DESCRIPTION OF EMBODIMENTS

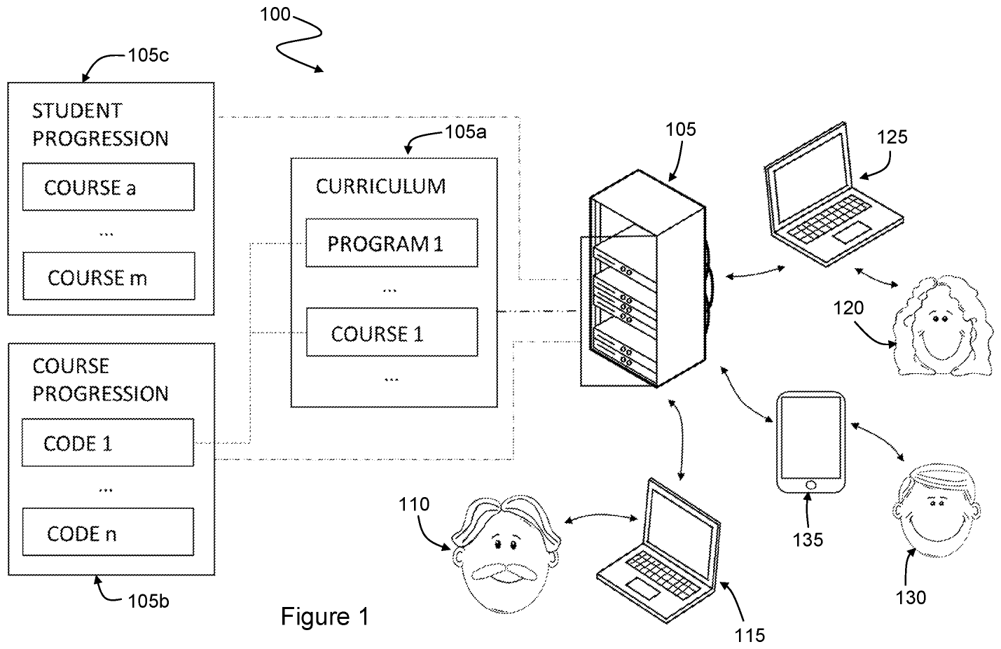

FIG. 1 illustrates a curriculum management system 100, according to an embodiment of the present invention. The curriculum management system 100 is adapted to enable educational institutions, such as universities, to efficiently manage their curriculum, to assist students in selecting courses in a program, and to allow students to manage their course progression in the program.

In the context of the present specification, a program refers to a collection of courses taken to complete a qualification, such as a Bachelor of Science. Each program has a structure and rules sufficient to determine whether a student has met the requirements for the award.

The courses are designed, calibrated, and sequenced to scaffold skills and knowledge over the duration of a program such that they form introductory (100-level), developing (200-level), and advanced courses (300- and 400 level etc) with dependencies and pre-requisites.

The courses include required courses, where the student must complete the course to complete the program, constrained elective courses, where a student must choose a course from a limited set of options, and unconstrained electives, where a student can choose any course if they meet the pre-requisites of that course. The programs may also contain study components such as majors and minors. The skilled addressee will, however, readily appreciate that courses could include other program requirements and assigned coding elements to optimise the timing of their completion in relation to other courses. For example, a not-for-credit laboratory induction module or pre-placement working with children training that must be completed prior to enrolment in another for-credit course may be considered a course.

The courses are generally taken over two study periods, herein referred to as semester 1 and semester 2. In the case of a three-year program taken in such manner, the semesters are numbered sequentially, from the first semester of study (semester 1), the second semester of study (semester 2), the third semester of study (semester 3), etc, being six semesters in total. The skilled addressee will, however, readily appreciate that courses may be taken over more than two study periods, such as for programs including a summer trimester, and that study periods need not necessarily be semesters, such as for programs run over four terms.

The system 100 includes a central server 105 with which a university administrator 110 interacts using a computing device 115, such as a laptop computer. The university administrator 110 may add courses, define when the courses are available, define programs, including what courses are required in a program, and perform any other applicable tasks associated with the curriculum.

This course data and program data are then entered into a curriculum data store 105a associated with the server 105, which may be made publicly available, e.g. through the Internet. As an illustrative example, the educational institution may provide a website on which the course data and the program data is displayed. Similarly, the curriculum data may be used to generate aspects of program handbooks or other material.

Furthermore, one or more program administrators 120 also interacts with the server 105 using a computing device 125, such as a laptop computer. The program administrator 120 supplements the information entered by the university administrator 110 relating to a specific program, and adds prioritisation data to each course associated with a program.

The program administrators 120 may be responsible for one or more programs, and generally take a much more detailed approach to the program than the university administrator 110. As an illustrative example, the program administrators 120 may interact with the students to help students identify appropriate courses, or otherwise liaise with students and staff in relation to the program.

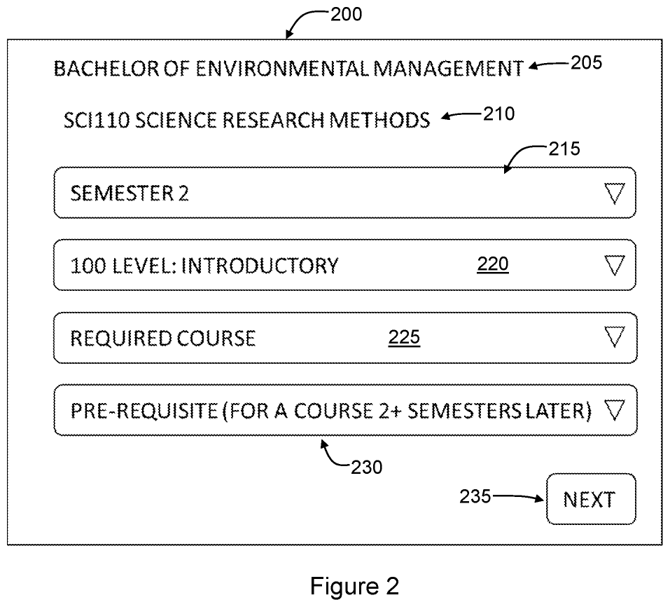

FIG. 2 illustrates a screenshot 200 of a program data entry screen of the system 100 of FIG. 1, according to an embodiment of the present invention. The program data entry screen enables the program administrators 120 to enter data relating to courses and the program, from which codes will be generated to assist in prioritising the courses within the program.

The program data entry screen is specific to a particular program, in this case a Bachelor of Environment Management, and includes a program identifier 205, identifying the particular program. A particular program may have more than one identifier, each of which relates to a different version of the program containing different requirements. The program data entry screen enables the program administrator 120 to enter prioritisation details regarding a plurality of courses in the particular program. The data relating to each of the courses may be entered sequentially, and the program data entry screen includes a course identifier 210, relating to the specific course being entered, in this case SCI110 Science Research Methods, thereby enabling the program administrator 120 to get a quick overview of the course in relation to which data is being entered.

The program data entry screen includes a semester selection menu 215, enabling the program administrator 120 to enter details regarding a preferred semester of the program in which the course should be completed (e.g. semester 2). As discussed above, the program may be studied over a plurality of semesters (e.g. typically 6 semesters for a three-year program), with each semester numbered sequentially.

The program data entry screen includes a level selection menu 220, enabling the program administrator 120 to enter details regarding the level of the course (e.g. 100 Level: Introductory). The courses may be categorised into any suitable level system, such as introductory (e.g. 100-level) courses, developing (e.g. 200-level) courses, and advanced (e.g. 300- and 400 level, etc) courses.

The program data entry screen further includes a requirement entry menu 225, enabling the program administrator 120 to enter details regarding whether the course is required in the program or not (e.g. required course). Several different levels of requirement may be provided, including required (or compulsory), recommended and optional. The different levels of requirement may be arranged in relation to study components such as majors and minors.

Finally, the program data entry screen includes a pre-requisite entry menu 230, which enables the program administrator 120 to enter details of any future courses to which this course is a pre-requisite. The pre-requisite entry menu 230 enables not only the identification of whether any future courses have this course as a pre-requisite, but also when that future course occurs. This enables differentiation between courses that are pre-requisites for courses coming shortly after in the program, and those which are later in the program (e.g. pre-requisite for a course that is 2+ semesters later).

As discussed above, a program will generally include a plurality of courses, and the program data entry screen will sequentially consider each of the courses. In such case, a next button 235 is used to navigate between courses, upon which the course identifier 210 is updated, enabling the program administrator 120 to get a good overview of which course they are entering data in relation to.

While the above description has described the university administrator 110 initially entering curriculum data, followed by the program administrator 120 entering program specific data, such data entry need not happen at or near the same time. In many cases, universities will already have curriculum data in one or more systems, which may have been entered years before the program administrator 120 enters data relating to the program. Accordingly, the system 100 is particularly suitable for use together with one or more legacy systems, such as prior art curriculum management systems, and does not require the university administrator 110 to also enter data.

As the program administrator 120 enters data relating to the courses, as discussed above, a code is generated for the course in relation to the specific program. As such, each course will have a code for each program in which the course is provided. Each course may also have a code for each study component, such as a major or minor, in which the course is provided. The code provides hierarchical prioritisation of the corresponding course in the corresponding program according to each of the above factors.

Each code comprises a sequence of numbers where each digit in the sequence relates to a specific aspect of the course's relationship with a program. Each of the aspects is arranged hierarchically in order of importance, which enables different aspects of a course's relationship within a program to be considered simultaneously.

In one embodiment, the code is provided as a four-digit number in the form A.BCD, where each of the characters A-D corresponds to a digit (for example 3.251). The A value relates to the study period in the sequence of study in an optimal study plan, such as a full-time optimal study plan. As an illustrative example, the value 1 in position A may indicate that the course is a first semester course in a full-time study plan of the program.

The B value relates to the year level of the course in relation to the program. As an illustrative example, the value 1 in position B may indicate that the course is a level 100 (or introductory) course.

The C value relates to whether the course is required, recommended or elective (including in a major or minor). A lower C-value is given to a required course than a recommended or elective course, to prioritise the required course over a recommended or elective course.

Finally, the D value relates to whether the course is a pre-requisite for a subsequent course. A lower D-value is given to courses that are pre-requisites for courses that are sooner rather than later.

An example of A values is shown in Table 1 below.

TABLE 1
Detailed description of A values

| Value | Description |
|---|---|
| 0 | Reserved for preparatory study or to prioritise courses |
| | as part of transition and teach out arrangements. |
| 1 | Indicates the first semester in the sequence of semesters |
| | in a three-year program taken full time |
| 2 | Indicates the second semester in the sequence of semesters |
| | in a three-year program taken full time |
| 3 | Indicates the third semester in the sequence of semesters |
| | in a three-year program taken full time |
| 4 | Indicates the fourth semester in the sequence of semesters |
| | in a three-year program taken full time |
| 5 | Indicates the fifth semester in the sequence of semesters |
| | in a three-year program taken full time |
| 6 | Indicates the sixth semester in the sequence of semesters |
| | in a three-year program taken full time |

An example of B values is shown in Table 2 below.

TABLE 2
Detailed description of B values

| Value | Description |
|---|---|
| 0 | Reserved for foundational study or to prioritise courses |
| | as part of transition and teach out arrangements. |
| 1 | Indicates course is 100 level: introductory |
| 2 | Indicates course is 200-level: developing |
| 3 | Indicates course is 300-level: advanced |
| 4 | Indicates course is 400-level: advanced |
| 5 | Indicates course is 500-level: specialised |
| | (typically post-graduate) |
| 6 | Indicates course is 600-level: specialised |
| | (typically post-graduate) |
| 7 | Indicates course is 700-level: specialised |
| | (typically post-graduate) |

An example of C values is shown in Table 3 below.

TABLE 3
Detailed description of C values

| Value | Description |
|---|---|
| 0 | Reserved for foundational study or to prioritise courses |
| | as part of transition and teach out arrangements. |
| 1 | Reserved to prioritise courses for limited offer, |
| | transition plans, and teach outs. |
| 2 | Reserved to prioritise courses for limited offer, |
| | transition plans, and teach outs. |
| 3 | Indicates a required course in the program. |
| 4 | Reserved to prioritise a course(s) for a specific reason. |
| 5 | Indicates a required course in an identified major that |
| | is not in the core required set of the program. |
| 6 | Indicates a required course in an identified minor that |
| | is not in the core required set of the program. |
| 7 | Indicates a recommended course. |
| 8 | Indicates an unconstrained elective. |
| 9 | Indicates a capstone course that should be taken at |
| | the very end of the program. |

An example of D values is shown in Table 4 below.

TABLE 4
Detailed description of D values

| Value | Description |
|---|---|
| 0 | Indicates the course is a pre-requisite for required courses |
| | in the following two semesters in the sequence. |
| 1 | Indicates the course is a pre-requisite for required courses |
| | that occur more than two semesters later. |
| 2 | Indicates the course is not a pre-requisite for other |
| | required courses in the program. |

The skilled addressee will readily appreciate that the four-digit code may be extended with additional digits, particularly for instances where program structures are more complex, or where a program may contain courses that are offered across semesters, trimesters, sessions, or similar.

It will be further understood that the four-digit code may be prepended or appended with other characters, or interspersed within a string with other characters.

When the codes are generated, they are stored in a course coding element data store 105b and each associated with the respective program and course. As such, the codes are each associated with one program and one course in the curriculum data store 105a.

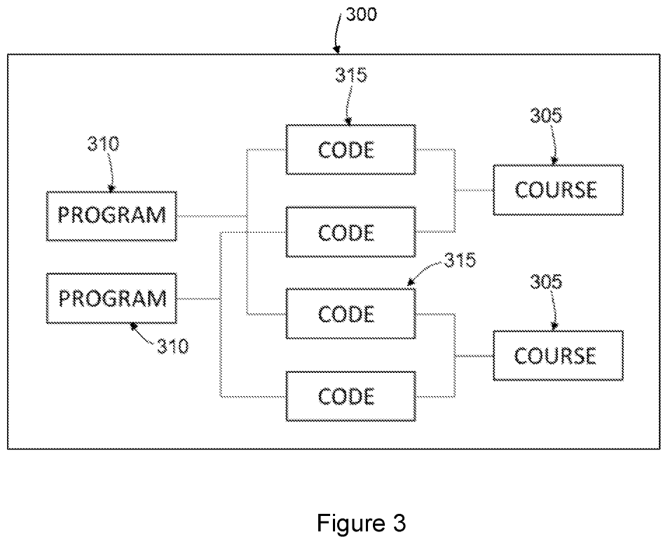

FIG. 3 illustrates schematic 300 of a data structure illustrating a relationship between the programs, courses and codes of the system 100, according to an embodiment of the present invention.

The data structure includes a plurality of course elements 305, corresponding to the courses offered by the educational institution, a plurality of program elements 310, corresponding to programs offered by the educational institution, and a plurality of coding elements 315, codifying a prioritisation of the course in the program.

Each course element 305 and program element 310 that is linked, is linked by a coding element 315, that codifies a prioritisation of the specific course in the specific program. As such, each course element 305 is linked to different program elements 310 by different coding element 315 to thereby enable different prioritisation of courses in different programs (or majors or minors).

Not all course elements 305 need be linked to all program elements 310, as not all courses are available in every program. However, every available combination of course element 305 and program element 310 is linked by a coding element 315. In fact, this data structure may provide an efficient way of identifying all courses associated with a program.

In addition to identifying the course and program, each course element 305 and program element 310 may include additional information relating to the course or program. As an illustrative example, information regarding availability of a course may be provided in a course element 305. Similarly, metadata relating to a program may be provided in a program element 310.

The schematic 300 is illustrated in a very simplistic form, and the skilled addressee will readily appreciate that there will be many more courses than there are programs, and as many courses are offered across multiple programs, there will generally be many more coding elements 315 than there are courses.

As discussed above, students are able to use the system 100 to get automated advice regarding enrolment of courses within a program, that is customised to their circumstances (e.g. what courses have already completed).

In particular, students 130 also interact with the server 105 using a computing device 135, such as a smartphone or tablet computer to manage their progression through the program, and to enroll in courses.

The student 130 is enrolled in a program, and must select and enroll in courses each semester. The server 105 uses the codes associated with each course and the program to automatically provide course suggestions to the student 130 based upon his or her individual circumstances. In particular, the server 105 proposes a set of courses based upon the program, the courses that the student has already completed, the semester, and the number of courses the student 130 wishes to study in that semester.

Each time a course is completed by the student 130, details of same are stored in a student progression data store 105c, which enables the completion of the courses to be considered when making future course suggestions. Similarly, if the student 130 has prior study, such details may be entered into the system 100 by the student or by a university administrator, which will then be stored in the student progression data store 105c.

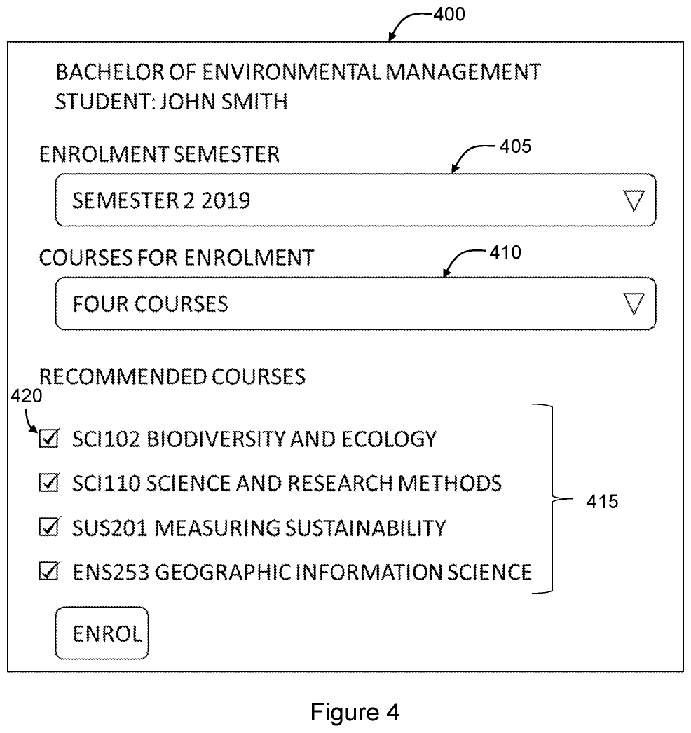

FIG. 4 illustrates a screenshot 400 of a student enrolment screen of the system 100 of FIG. 1, according to an embodiment of the present invention. The student enrolment screen enables the student to receive course recommendations that are tailored to the student's progress and the program in question, and enroll into courses.

The student enrolment screen includes an enrolment semester menu 405, which enables the student 130 to select a semester in which the enrolment is to be taken. Typically, the student 130 will enroll one semester at a time, but the system 100 may be readily adapted to enable the student to enroll in multiple semesters at the same time.

The student enrolment screen further includes a number of courses for enrolment menu 410, which enables the student to select the number of courses he or she wishes to enroll in. In the example of FIG. 4, the courses are of equal study load, and four courses corresponds a full-time semester. The skilled addressee will readily appreciate that in other circumstances, instead of the number of courses, other metrics, such as hours/week, or general metrics, such as “full time” and “part time” may be used to identify the student's desired study load.

When the enrolment semester and the number of courses for enrolment are selected, the server automatically recommends one or more courses. This is performed using the codes mentioned above, and the courses that the student has already completed.

The server 105 retrieves a list of all courses available for the enrolment semester that are associated with the program and their associated code for the program. The courses that the student has already completed are removed, as are the courses that are not relevant based upon the student's past studies or other factors. As an illustrative example, any courses that the student does not have the required pre-requisites for (or is unable to obtain the required pre-requisites) are removed.

The server 105 then solves an objective function, namely minimisation of the sum of the course coding elements for the number of courses that a student wishes to take. Alternatively, the server 105 selects the courses with the lowest course coding elements.

In solving the objective function or choosing the courses with the lowest progression codes, the server 105 also ensures that a set of constraints are satisfied. Typical constraints that must be satisfied include that: all required courses must be completed; all minor and major courses must be completed; the total unit value of all courses must not exceed a threshold (e.g. 288 units); pre-requisites must be completed before course is eligible; all courses must be completed within 16 study periods; and no more than 48 units can be taken in a study period.

As the courses which occur earlier in the optimal study sequence have lower code values, they are presented before those occurring later (and with higher values). However, the coding provides much more than simply a ranked order of courses and is able to capture considerable subtlety and nuance within a study sequence, as it takes into account a plurality of different factors. As such, the course coding elements need not replace existing numeric or alpha-numeric course codes institutions commonly used to identify their courses. In fact, the course progression codes are, in many embodiments, not normally visible to students.

Where a student has a choice of constrained or unconstrained electives, codes may be assigned to elective courses consistent with the level of academic skills and knowledge the student has acquired to date are suggested, while avoiding choosing courses for which they would be underprepared. E.g. generally, 100-level their first year, 200-level in their second year, 300-level in their third year etc.

In an alternative embodiment, coding elements are assigned to generic placeholder electives, for example ELC100, which indicate to the student that they have a choice of course at that position in the recommended sequence. The server then provides a list of courses that meet the requirements of available 100-level electives from which the student may choose, for example, through a drop-down list.

Where a student has a choice of required courses or constrained electives at the same level in a study period, selecting courses that are pre-requisites for required courses in subsequent study period will, all other things being equal, maintain the greatest number of possible future enrolment pathways.

Where a student has a choice of required courses or constrained electives at the same level in a study period and either course could be taken without advantaging or disadvantaging possible future enrolment pathways, the server 105 may provide the student with the option to choose between the courses, for example, through a drop-down list.

As courses may be added and removed, and not all courses are available in all periods, the coding is able to adapt without necessarily requiring any re-prioritisation of other courses. This may be possible as the courses may be prioritised independently of the prioritisation of other courses.

While the system 100 is illustrated with reference to a single program and a single student, the skilled addressee will readily appreciate that multiple students and multiple programs will generally be provided.

### EXAMPLE—2020 Bachelor of Environmental Management at the University of the Sunshine Coast (Australia)

The following example shows how codes would be assigned to an exemplary program (i.e. the 2020 Bachelor of Environmental Management at the University of the Sunshine Coast) using the system 100. The program was chosen because it represents a mid-way point between a fixed program that contains only required courses, and a more flexible program where students choose from majors and minors and have a variety of constrained and unconstrained elective choices. Although the codes can accommodate all of these structures, the chosen program in this example is well suited to illustrate the system.

The Bachelor of Environmental Management program is a three-year degree at Level 7 in the Australian Qualifications Framework. It comprises 24 courses of which 16 are required, four must be used to complete a minor from a specified list, and four are unconstrained electives. The academic year is divided into two 13-week long semesters that fall within two study periods covering the first and second half of the calendar year respectively. Most courses are only taught once per year, producing a set of Semester 1 and Semester 2 courses with very little duplication. Consequently, careful course sequencing is critical to student progress. A normal full-time study load would be four courses in each semester.

Tables 5 and 6 present the application of the coding protocol to the required courses in the program and the minors respectively. Where a course has a pre-requisite, it is shown in brackets. Based on the student's choice of minors, four of the Unconstrained Electives shown in Table 5 are replaced by the courses from the minors.

TABLE 5
Example codes for Bachelor of Environmental Management

| Semester | Code | Description |
|---|---|---|
| 1 | 1.002 | COR109 Communication and Thought |
| | 1.132 | ENS103 Earth’s Surface Processes |
| | 1.132 | ENS120 Intro to Environmental Management |
| | 1.172 | 100-level Recommended Elective |
| 2 | 2.130 | SCI102 Biodiversity and Ecology |
| | 2.131 | SCI110 Science Research Methods |
| | 2.172 | 100-level Recommended Elective |
| | 2.182 | 100-level Unconstrained Elective |
| 3 | 3.232 | SUS201 Measuring Sustainability |
| | 3.232 | ENS221 Plant Diversity and Ecology (Pre: SCI102) |
| | 3.232 | ENS253 Geographic Information Science |
| | 3.232 | ENP211 Planning and Environmental Law |
| 4 | 4.232 | ENS223 Environmental Impact Assessment |
| | 4.232 | ENS204 Climate Change Mitigation and Adaptation |
| | 4.232 | PUB262 Environmental Health Risk Management |
| | 4.282 | 200-level Unconstrained Elective |
| 5 | 5.332 | ENS300 Environmental and Resource Economics |
| | 5.332 | ENS351 Integrated Environmental Management |
| | 5.382 | 300-level Unconstrained Elective |
| | 5.382 | 300-level Unconstrained Elective |
| 6 | 6.332 | GEO310 Indigenous Peoples and the Environment |
| | 6.382 | 300-level Unconstrained Elective |
| | 6.382 | 300-level Unconstrained Elective |
| | 6.392 | ENS330 K’gari-Fraser Island Field Studies (Pre: SCI110)* |
| | 6.392 | ENS333 Special Field Studies Topic (Pre: SCI110)* |
| | 6.392 | SUS310 Sustainability Project* |
| | | (Pre: SUS101 and (SUS201 or SUS202 or SUS302) |
| | 6.392 | SRP301 Special Research Project* |
| | 6.392 | WPL310 Workplace Learning I* |

*Constrained electives, one of which must be chosen.

TABLE 6
Example codes for Minors in Bachelor of Environmental Management

| | |
|---|---|
| Code | Description |

Geospatial Analysis

| | |
|---|---|
| 3.231 | ENS253 Geographic Information Science |
| 5.362 | GEO301 Mapping with Drones |
| 4.262 | ENS254 Earth Observation: Remote Sensing and Surveying |
| 6.362 | ENS353 Applied Geospatial Analysis (Pre: ENS253) |

Urban Design and Town Planning

| | |
|---|---|
| 5.262 | ENP255 Urbanism and Urban Design |
| 5.462 | ENP411 Professional Planning Practice |
| 6.362 | ENP311 Planning Theory |
| 6.362 | ENP336 Strategic Infrastructure Planning |

Coastal and Marine Environments

| | |
|---|---|
| 5.261 | ENS282 Coastal and Marine Ecology |
| 5.362 | ENS317 Coastal Conservation Planning (Pre: SCI110 or ENS282) |
| 2.162 | ANM104 Marine Vertebrates |
| 6.362 | GEO302 Coastal Geomorphology |

Sustainability

| | |
|---|---|
| 1.161 | SUS101 Foundations of Sustainability |
| 3.261 | SUS201 Measuring Sustainability |
| 4.261 | SUS202 Communicating Sustainability |
| 6.362 | SUS302 Sustainability Problem Solving |

Global environmental security and policy

| | |
|---|---|
| 1.162 | INT140 An Introduction to International Studies |
| 5.262 | INT250 Forces of Change in International Politics |
| 2.162 | INT130 Global Environmental Politics |
| 4.262 | INT257 International Security and Environment |

When a student selects a minor, the courses associated with the minor are included with the base courses when performing the optimisation. Where the same course may appear in the base set of required courses for the program and also form part of the minor, the server determines the course with the lower coding element and removes the duplicate with the higher coding element. For example, if a student selects the Geospatial Analysis minor the course ENS253 Geographic Information Science is part of the required courses for the program and is also part of the required courses for the minor. However, where it occurs in the minor ENS253 is a pre-requisite for ENS353 Applied Geospatial Analysis. Therefore, the server 105 identifies that ENS253 has a lower coding element when it appears in the minor (3.231) compared to when it appears in the program set (3.232). The server 105 then removes the duplicate with the higher value and uses the coding element associated with ENS253 in the minor which increases the priority of the course to ensure the greatest possible future enrolment pathways for the student.

The coding described in Tables 5 and 6 above has been generated using the coding specification set out in Tables 1 to 4. It produces a sequence of courses in any semester that broadly reflect an importance of one course over others in the program.

The example coding prioritises required courses over courses in the minor, which is well suited to situations where the student's final choice of minor is made later in the program and they make course decisions on their likely choice of minor. Alternatively, the program administrators 120 may feel that it is important that students choose their minor at the outset of the program to optimise the sequencing, and in such case, the coding may be modified such that the required courses and the minor courses should be given the same value in the C position. For example, the code 2.162 for INT130 Global Environmental Politics in the Global Environmental Security and Policy minor would be changed to 2.132, which would give it equal importance to required courses. Small changes to the approach to assigning the codes allows the program administrators 120 to tailor the coding to more open-ended programs where majors and minors are optional or situations where a major or minor is required.

As discussed above, the codes can include additional digits to address more complex program structures, or for any other purpose as may be desirable. For example, the Bachelor of Nursing Program at the University of the Sunshine Coast (Australia) contains courses that are offered in semesters, trimesters, and sessions. This can be accommodated in a code by adding digits to the left of the decimal. For example, a six-digit code would be well suited to this program that follows the specification: ABC.DEF. In this case, A can be used to represent the sequence of study periods, B the semester or trimester of offer, and C the session of offer.

More generally, the skilled addressee will readily appreciate that the code may be modified in a large number of ways, without departing from the scope of the present invention. As an illustrative example, it is possible to remove the decimal from the code and maintain the functionality of the coding. The decimal is included in the examples above because this can assist those reviewing the codes to more easily break the code into two main elements: to the left of the decimal is the sequence of semesters and the course availability; to the right of the decimal is the course level, role in the program, and pre-requisite relationships.

It is also possible to substitute letters for one, one or more, or all of the numbers in the coding protocol. The overall approach could nevertheless be similar regarding sequencing the semesters, year level, requirement in the program, and pre-requisite dependencies. The minimisation could occur by choosing, as applicable the lowest alphabetical or alpha-numerical string values of the available course coding elements rather than minimising the sum of the codes. While potentially less intuitive for the person coding, one potential benefit of this method is that each letter in the alphabet has a base of 26 whereas each numeral only has a base of 10, such that letters could allow for a more compact course progression code.

For example, to the left of the decimal point in the course progression value, the sequence of numbers could be replaced by a sequence of letter that correspond to the sequence of study period in a program, and the course's availability by semester, trimester, session etc. Using the Bachelor of Nursing Science example previously presented, the format of the code could be reduced from XXX.XXX to XX.XXX or less.

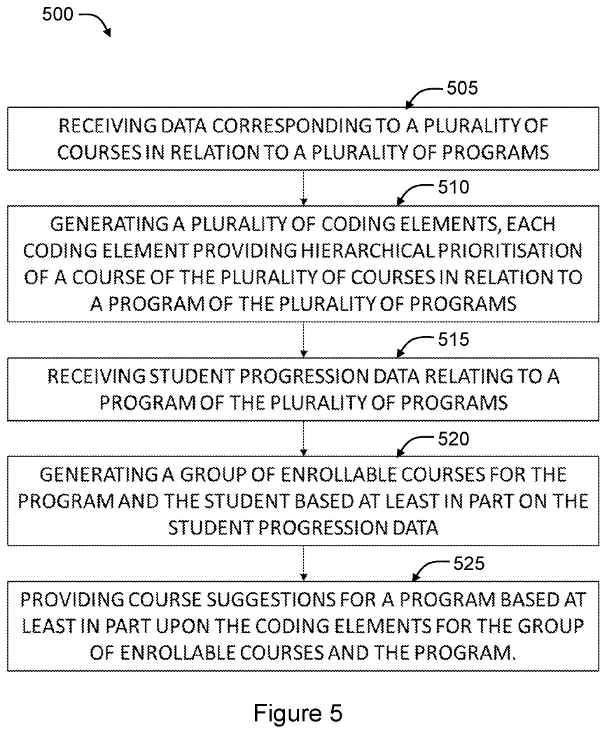

FIG. 5 illustrates a curriculum management method 500, according to an embodiment of the present invention. The method may be similar, or substantially identical, to the method performed by the system 100, described above.

At step 505, data corresponding to a plurality of courses in relation to a plurality of programs is received. The data may be provided in response to questions, such as those provided in relation to FIG. 2.

At step 510, a plurality of coding elements is generated. Each coding element provides a hierarchical prioritisation of a course of the plurality of courses in relation to a program of the plurality of programs. The coding elements may comprise a numeric or alpha-numeric code, as discussed above in relation to the system 100.

At step 515, student progression data is received relating to a program of the plurality of programs. The student progression data will generally identify at least one student and at least one program, and identify what courses that student has completed within that program. The student progression data may also contain a nominated study component such as a major or minor.

At step 520, a group of enrollable courses is generated for the program and the student based at least in part on the student progression data. The group of enrollable courses may be generated by identifying all courses within the program, and removing courses which are not relevant to the student, which are not available in the semester of interest, or which the student has already completed.

Finally, at step 525, course suggestions are provided for a program based at least in part upon the coding elements for the group of enrollable courses and the program. As discussed above, this may include solving an objective problem relating to the codes (such as minimising a sum of codes).

In addition to using the coding elements, the method may include course data including: unit value; availability by semester, session, or trimester; pre-requisites and co-requisites; and other enrolment restrictions. The method may also ensure that the suggestions comply with one or more program rules (e.g. must complete 288 units, must not exceed 10 years of part-time study, must not enroll in more than four courses per study period, etc.). The number of courses suggested may be determined by information that the student provides about the number of courses that they wish to enroll in.

Furthermore, and as detailed above, the method may also take into consideration majors and minors that the student has declared.

In addition to simply providing course suggestions, the methods and systems described above may identify certain courses being of equivalent priority, and provide one or more such courses to the student for selection.

The system may also provide additional information to a student, including providing the student with an indication of how many semesters of full-time study remain and flag when a student nominating to study part time will exceed the maximum allowable time.

The suggestions based upon codes may be supplemented with one or more rules. As an illustrative example, a certain course may be required in the first semester of study, if it hasn't yet been completed. Such course thus need not be associated with any code, as it may be automatically added to the first semester of study.

The methods and system may also consider the scenario where a course is offered in both semesters each year, compared to other courses that are only offered one semester per year. In such case, the methods and systems may place the course in the semester that best balances the study sequence (e.g. allows it to be completed in the minimal time or balances electives across semesters or years).

The above descriptions use the terms program, study component, and course. However, the skilled addressee will readily appreciate that other terminology may be used, and embodiments of the present invention may be used with other types of study or training. As an illustrative example, embodiments of the invention may be used with reference to courses spread out over four terms per year. Similarly, a course may comprise a program of study made up of individual units.

It will be further appreciated that, while reference has been made to universities herein, embodiments of the invention may be used in the context of any other suitable educational institutions, such as trade colleges etc.

Certain benefits and advantages of at least some embodiments of systems and/or methods as described herein will now be further discussed.

Advantageously, the systems and methods can enable educational institutions to provide efficient and detailed course recommendations to students, in a manner that is considerably more efficient than utilising student advisors and program managers to provide detailed advice.

The systems and methods can automate the provision of expert advice and thereby provide optimal course guidance to students for a program by performing program specific prioritisation of courses. Furthermore, by providing hierarchical prioritisation, multiple factors may be considered in the prioritisation, each having varying levels of importance. As a result, the systems and methods are able to capture considerable subtlety and nuance in prioritisation of the courses and the subsequent guidance it provides to users.

The systems and methods can provide accurate and consistent course guidance to students regarding the optimal set of courses that a student should take in a given study period that takes into account, for example, complex program requirements, consistency with best-practice curriculum design, course availability and pre-requisite relationships, prior study undertaken, and transition arrangements arising from program changes.

Advantageously, the systems and methods provide the ability of curriculum designers to codify the intended progression of knowledge and skills acquisition in a program, including details of optimal learning sequences and implicit and explicit course requirements. This offers substantial opportunity to improve student learning experiences and academic success.

It will be further appreciated that the systems and methods can be used to supplement course guidance provided to students by, for example, academic support staff or program advisors or the like. This can assist with improving consistency, accuracy, and efficiency of student guidance.

Advantageously, the protocol for assigning course codes according to the systems and methods is relatively intuitive, and could be implemented by student advisors and program managers using little more than recommended study plans and basic knowledge of constructive alignment principles as input.

Each course is assigned a code irrespective of the codes of other courses unless there are dependencies such as pre-requisite relationships, and therefore the process of adding or removing courses is greatly simplified.

Advantageously, the systems and methods can enable students to relatively easily ensure that the courses satisfy complex program requirements, are consistent with best-practice curriculum design principles, and take account of course availability and dependencies. As a result, the methods and systems may increase the potential for a student to successfully acquire, apply, and demonstrate the scope and depth of knowledge, skills, and graduate attributes that the award encompasses in the minimum possible time.

Furthermore, the student's prior study can be considered when making suggestions, and the methods and systems can accommodate transition arrangements arising from program changes.

It will be appreciated that the methods and systems can be particularly useful for students that deviate from ‘standard’ full and part time programs, such as assisting a student to map their study over a long-term (e.g. ten-year) period of part time study.

As described above, the methods and systems may incorporate a data store including a plurality of student progression elements each corresponding to a student and a program, the student progression element including information regarding completion of a version of the program. This configuration can be particularly advantageous to accommodate scenarios wherein changes are made to a program, such that there exist different versions of the program that contain most or some of the same courses but wherein coding elements may differ. The provision of specific students with tailored or custom course coding can be advantageous in this context, to facilitate transition from one version of a program to another.

Advantageously, typical embodiments of the systems and methods do not require computationally intensive processes such as datamining, artificial intelligence (AI), or predictive algorithms etc. as are known in the prior art. Rather, the systems and methods can be implemented using relatively simple applications or even interpreted scripts. By way of non-limiting example, the skilled person will readily appreciate that suitable processing in the context of the systems and methods could be achieved using a Microsoft Excel macro or a script written in Python, Perl, or R, etc.

In this specification, the indefinite articles ‘a’ and ‘an’ are not to be read as singular indefinite articles or as otherwise excluding more than one or more than a single subject to which the indefinite article refers. For example, ‘a’ program includes one program, one or more programs, and a plurality of programs.

In this specification, the terms ‘comprises’, ‘comprising’, ‘includes’, ‘including’, and similar terms are intended to mean a non-exclusive inclusion, such that an apparatus, system, or method that comprises or includes a list of elements need not have those elements solely, and may well have other elements not listed.

In this specification, the terms ‘consisting essentially of’ and ‘consists essentially of’ are intended to mean a non-exclusive inclusion only to the extent that, if additional elements are included beyond those elements recited, the additional elements do not materially alter basic and novel characteristics. That is, an apparatus, system, or method that ‘consists essentially of’ one or more recited elements includes those elements only, or those elements and any additional elements that do not materially alter the basic and novel characteristics of the apparatus, system, or method.

In this specification, unless the context requires otherwise, the terms ‘connection’, ‘connected’, ‘connecting’, and the like, are not to be read as limited to direct connections and may also include indirect connections. For example, unless the context requires otherwise, a stated first component ‘connected’ to a stated second component may be connected via, through, or by, one or more unstated components.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A curriculum management system, comprising:
a data store comprising a plurality of coding elements, each coding element providing hierarchical prioritisation of a course comprising a plurality of course elements in a program comprising a plurality of program elements, wherein each of the plurality of course elements is linked to different coding elements of the plurality of coding elements; and
at least one server, configured to identify courses associated with a program and provide course suggestions for the program based at least in part upon the coding elements,
wherein each coding element comprises a plurality of hierarchically arranged coding sub-elements including at least three of:
a study period sub-element, indicating a preferred study period characteristic of the course in the program;
a course level sub-element, indicating a level characteristic of the course in the program;
a course requirement sub-element, indicating a requirement characteristic of the course in the program; and
a course pre-requisite sub-element, indicating a pre-requisite characteristic of the course in the program, and
wherein each coding element is or comprises a value based on the plurality of sub-elements, wherein hierarchical prioritisation of the course with reference to other courses in the program is performed by comparing a magnitude of the coding element value of the course to coding element values of other courses in the program, and wherein the courses associated with a program are identified by the coding elements.

2. The system of claim 1, wherein the coding elements provide hierarchical prioritisation of the course in the program independently of a prioritisation of other courses in the program.

3. The system of claim 1, wherein a plurality of student progression elements are used in conjunction with the plurality of coding elements to provide course suggestions for the program.

4. The system of claim 1, wherein the course suggestions are provided in a user interface that enables a student to enroll in a suggested course or courses.

5. The of claim 4, wherein the user interface is a graphical user interface.

6. The system of claim 1, wherein each coding element comprises the study period sub-element; the course level sub-element; the course requirement sub-element; and the course pre-requisite sub-element.

7. The system of claim 1, wherein each coding element comprises a string comprising the coding sub-elements, wherein the order of the respective sub-elements as present in the string is: the study period sub-element; the course level sub-element; the course requirement sub-element; the course pre-requisite sub-element.

8. The system of claim 1, wherein each coding element comprises, letters and/or numbers.

9. The system of claim 8, wherein the sub-elements of the coding elements comprise a letter or a number.

10. The system of claim 9, wherein one or more, or all, of the sub-elements are non-binary sub-elements.

11. The system of claim 1, wherein the course suggestions are provided based on minimising the magnitude of the value of the coding element or coding elements of the course or courses suggested.

12. The system of claim 1, wherein the course suggestions are provided on the basis of solving an objective function using the coding element of the course and coding elements of other courses in the program.

13. The system of claim 12, wherein the course suggestions are provided by generating a list of courses available for enrolment and performing the objective function using the list of courses available for enrolment.

14. A curriculum management method including steps of:
receiving, on a data interface, a plurality of coding elements, each coding element providing hierarchical prioritisation of a course in a program; and
providing course suggestions for a program based at least in part upon the coding elements,
wherein each coding element comprises a plurality of hierarchically arranged coding sub-elements including at least three of:
a study period sub-element, indicating a preferred study period characteristic of the course in the program;
a course level sub-element, indicating a level characteristic of the course in the program;
a course requirement sub-element, indicating a requirement characteristic of the course in the program; and
a course pre-requisite sub-element, indicating a pre-requisite characteristic of the course in the program, and
wherein each coding element is or comprises a value based on the plurality of sub-elements, and wherein hierarchical prioritisation of the course with reference to other courses in the program is performed by comparing a magnitude of the coding element value of the course to coding element values of other courses in the program.

15. A curriculum management method including a step of:
providing course suggestions for a program based at least in part upon a plurality of coding elements, each coding element providing hierarchical prioritisation of a course in a program,
wherein each coding element comprises a plurality of hierarchically arranged coding sub-elements including at least three of:
a study period sub-element, indicating a preferred study period characteristic of the course in the program;
a course level sub-element, indicating a level characteristic of the course in the program;
a course requirement sub-element, indicating a requirement characteristic of the course in the program; and
a course pre-requisite sub-element, indicating a pre-requisite characteristic of the course in the program, and
wherein each coding element is or comprises a value based on the plurality of sub-elements, and wherein hierarchical prioritisation of the course with reference to other courses in the program is performed by comparing a magnitude of the coding element value of the course to coding element values of other courses in the program.
